(19) United States
(12) Patent Application Publication
(10) Pub. No.: US 2024/0422869 A1
(43) Pub. Date: Dec. 19, 2024

(54) CONTROL METHOD FOR A HEATING DEVICE AND A HEATING DEVICE

(71) Applicants: QINGDAO HAIER REFRIGERATOR CO., LTD., Qingdao (CN); HAIER SMART HOME CO., LTD., Qingdao (CN)

(72) Inventors: Zhiqiang HAN, Qingdao (CN); Chunyang LI, Qingdao (CN)

(21) Appl. No.: 18/702,270

(22) PCT Filed: Sep. 28, 2022
(86) PCT No.: PCT/CN2022/122247

§ 371 Date: Apr. 17, 2024

(30) Foreign Application Priority Data
Oct. 18, 2021 (CN) 202111211440.8

(51) Int. Cl. H05B 6/68; H05B 6/70

(52) U.S. Cl. CPC H05B 6/687; H05B 6/705

(57) ABSTRACT

A heating device and control method therefor. The device includes a cylinder for placing an object to be processed and an electromagnetic wave generating system for generating electromagnetic wave signals to heat the object. At each preset time interval, the electromagnetic wave generating system is controlled to adjust the frequency of the generated electromagnetic wave signal within a preset selectable frequency range, and ensure the system meets a preset matching condition. The frequency of the signal that meets the preset matching condition each time is recorded, and the change amount in frequency of the signal that meets the preset matching condition from before the preset number of matches to the current match is calculated. Operation of the system is terminated when any one of preset termination conditions is met. The preset termination conditions include the change amount being less or equal to a preset change threshold, enabling the cessation of heating of food at a state desired by the user, particularly suitable for food defrosting.

### CROSS-REFERENCE TO RELATED APPLICATIONS

The present application is a national phase entry of International Application No. PCT/CN2022/122247, filed Sep. 28, 2022, which claims priority to Chinese Patent Application No. CN202111211440.8, filed Oct. 18, 2021, which are incorporated herein by reference in their entirety.

### TECHNICAL FIELD

The present application relates to the field of food processing, and in particular to a control method for an electromagnetic wave heating device and a heating device.

### BACKGROUND

During the freezing process, the quality of food is preserved; however, frozen food needs to be thawed before processing or consumption. To facilitate thawing for users, electromagnetic wave heating devices are commonly used to thaw food.

Thawing food with electromagnetic wave heating devices not only offers rapid and efficient thawing but also minimizes the loss of nutritional components in food. Nonetheless, determining how to stop heating food at a state desired by users when the food is already at a higher temperature has been a technical problem that the skilled person in this field wants to solve. In the prior art, the rate of change of S11 is used to determine whether the thawing of the object to be processed is completed, however, due to the high heating efficiency of the electromagnetic wave, the temperature of food changes very rapidly, and slight changes in external factors (such as frequency) can cause rapid changes in S11, leading to a high error rate.

Reference to any prior art in the specification is not, and should not be taken as, an acknowledgment or any form of suggestion that this prior art forms part of the common general knowledge in Europe or any other jurisdiction or that this prior art could reasonably be expected to be understood and regarded as relevant by a person skilled in the art.

### SUMMARY

A first aspect of the present application aims to provide a control method for an electromagnetic wave heating device, which utilize new heating termination conditions to determine whether heating is complete.

A further objective of the first aspect of the application is to shorten the frequency matching time and the calculation time for the change amount.

Another further objective of the first aspect of the application is to stop heating more precisely.

A second aspect of the present application aims to provide an electromagnetic wave heating device.

According to the first aspect of the present application, a control method for a heating device is provided, the heating device comprises a cylinder for placing an object to be processed, and an electromagnetic wave generating system for generating electromagnetic wave signals to heat the object to be processed, wherein the control method comprising:
frequency matching step: at each preset time interval, controlling the electromagnetic wave generating system to adjust the frequency of the generated electromagnetic wave signal within a preset selectable frequency range, and ensuring the electromagnetic wave generating system meets a preset matching condition;
step of calculating a change amount: recording the frequency of the electromagnetic wave signal that meets the preset matching condition each time, and calculating the change amount in frequency of the electromagnetic wave signal that meets the preset matching condition from before the preset number of matches to the current match;
heating termination step: stopping the operation of the electromagnetic wave generating system when any one of preset termination conditions is met, wherein, the preset termination conditions comprise the change amount being less than or equal to a preset change threshold.

Optionally, in the frequency matching step, the minimum value of the preset selectable frequency range to the frequency of the electromagnetic wave signal that met the preset matching condition in the previous instance is used as a selectable frequency range for the current frequency matching step; and
in the step of calculating a change amount, the difference between the frequency of the electromagnetic wave signal that meets the preset matching condition before the preset number of matches and the current match is calculated as the change amount.

Optionally, in the step of calculating a change amount, the difference between the frequency of every two adjacent electromagnetic wave signals that meet the preset matching condition is calculated, and all such differences are summed to obtain the change amount.

Optionally, in the first frequency matching step, the preset matching condition comprises the power of the reflected wave signal returned to the electromagnetic wave generating system being minimal.

Optionally, after the first frequency matching step is executed, it further comprises:
time determination step: determining a remaining heating time for the object to be processed based on the frequency of the electromagnetic wave signal that first meets the preset matching condition according to a preset comparison table, wherein, the comparison table records the relationship between frequency and the remaining heating time; and
the preset termination condition also comprises the heating time for the object to be processed being longer than or equal to the remaining heating time after the time determination step.

Optionally, when executing the frequency matching step for the first time and the preset number of matches closely following the first time, the preset matching condition comprises the power of the reflected wave signal returned to the electromagnetic wave generating system being minimal; and after executing the frequency matching step for the preset number of matches, the control method further comprises:
time determination step: determining a remaining heating time for the object to be processed based on a sum of the differences in frequency between every two adjacent electromagnetic wave signals that meet the preset matching condition within the first time and the preset number of matches closely following the first time according to a preset comparison table; wherein,
the comparison table records the relationship between the sum of the differences and the remaining heating time; and
the preset termination condition also comprises the heating time for the object to be processed being longer than or equal to the remaining heating time after the time determination step.

Optionally, after the time determination step, the preset matching condition comprises the ratio of the power of the reflected wave signal returned to the electromagnetic wave generating system and the power of the incident wave signal propagated by the electromagnetic wave generating system to the cylinder being greater than or equal to a preset ratio threshold;

When the condition of the preset matching condition being met occurs, the current frequency matching step is terminated.

Optionally, the preset number of matches is greater than or equal to 2.

Optionally, the preset time interval is 25 s˜40 s.

According to the second aspect of the present application, a heating device is provided, the heating device comprises:
a cylinder for placing an object to be processed;
an electromagnetic wave generating system, configured to generate electromagnetic wave signals for heating the object to be processed; and
a controller, configured to execute any one of the control methods.

The inventors of this application have creatively recognized that the change amount in frequency that achieves matching within the same time is relatively small, only near the phase transition region of water has a significant decrease and being influenced by the degree of frequency matching. Using the change amount in frequency that meets the frequency matching condition as a condition for judging heating termination provides a particularly accurate determination of whether to stop heating. This enables the heating of food to stop at a state desired by the user, especially suitable for food defrosting, preventing the object to be processed from being overly defrosted. Typically, when defrosting is complete, the temperature is around −4 to −2° C., which can prevent the production of blood water when the object to be processed is meat, making it easier for users to cut.

Furthermore, the application, in the frequency matching step and the step of calculating a change amount, uses the minimum value of the preset selectable frequency range to the frequency of the electromagnetic wave signal that met the preset matching condition in the previous instance as a selectable frequency range for the current frequency matching step, and uses the difference between the frequency of the electromagnetic wave signal that meets the preset matching condition before the preset number of matches and the current match as the change amount. This approach allows for the rapid and accurate determination of the electromagnetic wave signal frequency that meets the preset matching condition, shortening the operating time of the frequency matching step and the step of calculating a change amount, thereby reducing the impact of the frequency matching process on the quality of the object to be processed and improving the timeliness of determining whether the heating termination conditions are met.

Furthermore, the application, based on using the change amount in frequency that meets the frequency matching condition as a criterion for terminating heating, also adds the remaining heating time determined by the frequency that first meets the preset matching condition, or the change amount in frequency over several times of meeting the preset matching condition, as a condition for judging the heating termination. This further enhances the accuracy of determining whether to stop heating, thereby ensuring the processed object's excellent quality upon heating completion and improving user experience.

Through the detailed description of specific embodiments of the application, combined with the drawings provided below, those skilled in the art will gain a clearer understanding of the aforementioned and other objectives, advantages, and features of the invention.

As used herein, except where the context clearly requires otherwise, the term “comprise” and variations of the term, such as “comprising”, “comprises” and “comprised”, are not intended to exclude further features, components, integers or steps.

### BRIEF DESCRIPTION OF THE DRAWINGS

The following descriptions of specific embodiments of the application refer to the accompanying drawings in an illustrative rather than restrictive manner. The same reference numbers in the drawings indicate identical or similar parts or components. Those skilled in the art should understand that these drawings are not necessarily drawn to scale. In the drawings:

FIG. 1 is a schematic structural diagram of a heating device according to an embodiment of the application;

FIG. 2 is a schematic structural diagram of the controller in the heating device shown in FIG. 1;

FIG. 3 is a schematic flowchart of a control method for a heating device according to an embodiment of the application;

FIG. 4 is a schematic detailed flowchart of the control method for a heating device according to an embodiment of the application;

FIG. 5 is a schematic detailed flowchart of the control method for a heating device according to another embodiment of the application.

### DETAILED DESCRIPTION OF EMBODIMENTS

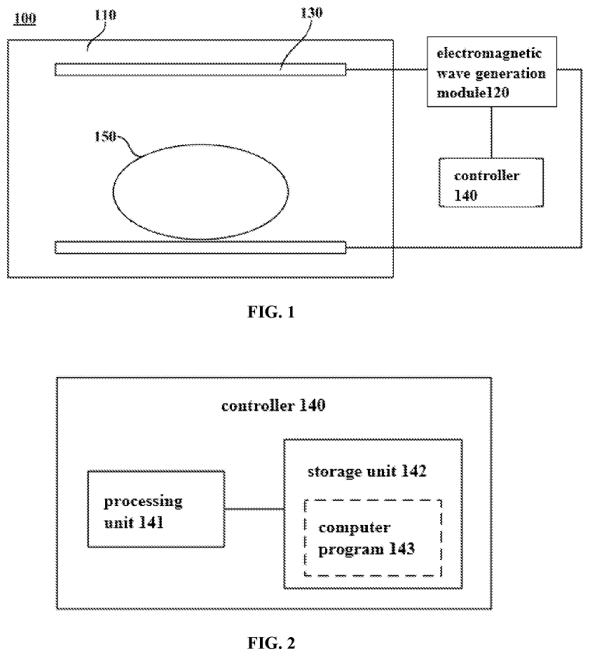

FIG. 1 is a schematic structural diagram of a heating device 100 according to an embodiment of the application. Referring to FIG. 1, the heating device 100 may comprise a cylinder 110, a door, an electromagnetic wave generation system, and a controller 140.

Specifically, the cylinder 110 can be used to contain the object to be processed 150. The door can be used to open and close the access port of the cylinder 110. Both the cylinder 110 and the door can have electromagnetic shielding features to reduce electromagnetic leakage.

The cylinder 110 can be made of metal and set to be grounded to further enhance the safety performance of the heating device 100.

The electromagnetic wave generation system may be at least partially disposed within the cylinder 110 or accessible to the cylinder 110, to emit electromagnetic waves into the cylinder 110 to heat the object to be processed 150.

The electromagnetic wave generation system may comprise an electromagnetic wave generation module 120, a radiation antenna 130 electrically connected to the electromagnetic wave generation module 120, and a power supply for powering the electromagnetic wave generation module 120.

The electromagnetic wave generation module 120 can be configured to generate electromagnetic wave signals. The radiation antenna 130 can be located within cylinder 110 to produce electromagnetic waves within cylinder 110, thereby heating the object to be processed 150 located inside the cylinder 110. Wherein, the electromagnetic wave generation module 120 may comprise a variable frequency source and a power amplifier.

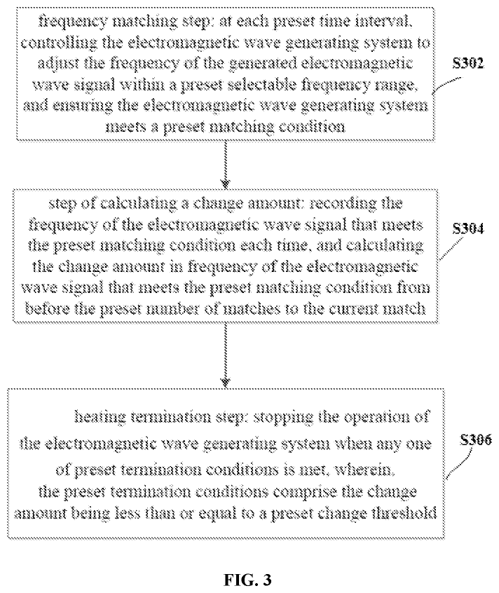

FIG. 2 is a schematic structural diagram of the controller 140 in FIG. 1. Referring to FIG. 2, the controller 140 may comprise a processing unit 141 and a storage unit 142. The storage unit 142 stores a computer program 143, when the computer program 143 executed by the processing unit 141, is used to implement the control method of the embodiment of the application.

Specifically, the processing unit 141 can be configured to control the electromagnetic wave generation system at each preset time interval t to adjust the frequency of the generated electromagnetic wave signal within a preset selectable frequency range, ensuring the electromagnetic wave generation system meets a preset matching condition, recording the frequency of the electromagnetic wave signal that meets the preset matching condition each time, and calculating the change amount in frequency of the electromagnetic wave signal that meets the preset matching condition from before the preset number of matches to the current match. When the change amount is less than or equal to a preset change threshold S, the electromagnetic wave generation system is controlled to stop operating.

The heating device 100 of the application stops the operation of the electromagnetic wave generation system when the change amount in frequency that meets the frequency matching condition is less than or equal to the preset change threshold S, thus halting the heating of food at a state desired by the user, especially suitable for defrosting food. This prevents the object to be processed 150 from being overly defrosted, when defrosting is complete, the temperature is around −4 to −2° C., avoiding the production of blood water when the object to be processed 150 is meat, making it easier for users to cut.

In this application, the preset time interval t can be 25 s to 40 s, such as 25 s, 30 s, or 40 s, to prevent misjudgment.

The selectable frequency range can be 400 MHz to 500 MHz, to ensure the uniform temperature of the object to be processed 150 and the efficiency of heating the object to be processed 150.

The preset number of matches can be greater than or equal to 2, such as 3, to prevent misjudgment. The preset number of matches can also be 1, meaning the change amount is the difference in frequency of the electromagnetic wave signal that meets the preset matching condition between two consecutive times.

During the frequency matching process, the power of the electromagnetic wave signal can be 5%˜10% of the power during the normal heating process, to reduce the adverse effect on the object to be processed 150.

In some embodiments, the processing unit 141 can be configured to use the minimum value of the preset selectable frequency range to the frequency of the electromagnetic wave signal that met the preset matching condition in the previous instance as the selectable frequency range for the current frequency matching step, and calculate the difference between the frequency of the electromagnetic wave signal that meets the preset matching condition before the preset number of matches and the current match as the change amount. This allows for the rapid and accurate determination of the electromagnetic wave signal frequency that meets the preset matching condition, thereby reducing the impact of the frequency matching process on the quality of the object to be processed 150 and improving the timeliness of determining whether to stop heating.

In other embodiments, the processing unit 141 can be configured to first calculate the difference between the frequency of every two adjacent electromagnetic wave signals that meet the preset matching condition, and then sum all such differences to obtain the change amount, to enhance accuracy.

In some embodiments, at the first frequency matching, the matching condition can be: the power of the reflected wave signal returned to the electromagnetic wave generating system being minimal, to facilitate subsequent frequency matching and shorten the time for subsequent frequency matching.

The processing unit 141 can be configured to determine a remaining heating time T for the object to be processed 150 based on the frequency of the electromagnetic wave signal that first meets the preset matching condition according to a preset comparison table. When the continuation of the heating time for the object to be processed 150 is longer than or equal to the determined remaining heating time T, the electromagnetic wave generating system is controlled to stop operating, to further ensure the object to be processed 150 has excellent quality upon the completion of heating. The comparison table records the relationship between different frequencies and the remaining heating time T.

In other embodiments, when performing frequency matching for the first time and for a preset number of matches closely following the first time, the matching condition can be the same: the power of the reflected wave signal returned to the electromagnetic wave generating system being minimal.

The processing unit 141 can be configured to determine a remaining heating time T for the object to be processed 150 based on a sum of the differences in frequency between every two adjacent electromagnetic wave signals that meet the preset matching condition within the first time and the preset number of matches closely following the first time according to a preset comparison table. When the continuation of the heating time for the object to be processed 150 is longer than or equal to the determined remaining heating time T, the electromagnetic wave generating system is controlled to stop operating, to stop heating the object to be processed 150 more accurately and further ensure the object to be processed 150 has excellent quality upon heating completion. The comparison table records the relationship between the sum of the differences and the remaining heating time T.

In further embodiments, after determining the remaining heating time T, the matching condition can be: the ratio of the power of the reflected wave signal returned to the electromagnetic wave generating system and the power of the incident wave signal propagated by the electromagnetic wave generating system to the cylinder 110 is greater than or equal to a preset ratio threshold. The preset ratio threshold can be 70%˜80%.

When the ratio of the power of the reflected wave signal and the power of the incident wave signal is greater than or equal to a preset ratio threshold, the current frequency matching step is terminated, to reduce the adverse impact on the object to be processed 150 and enhance heating efficiency.

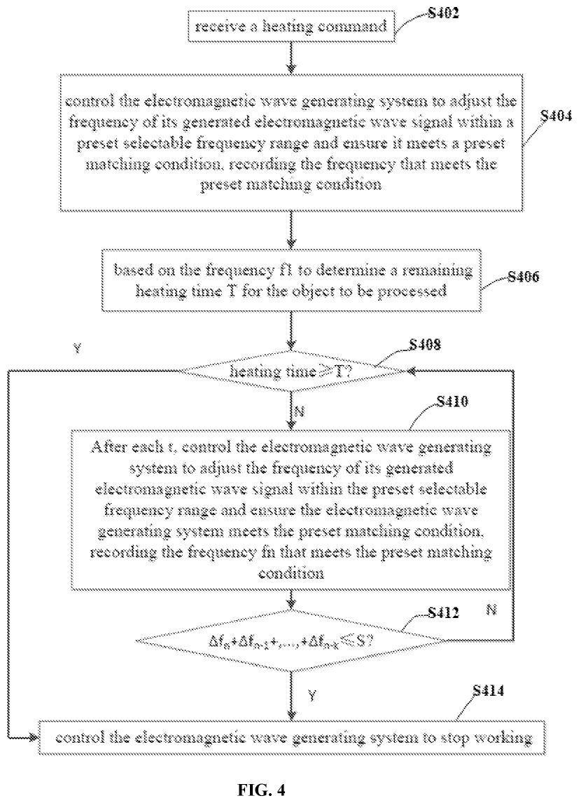

FIG. 3 is a schematic flowchart of a control method for a heating device 100 according to an embodiment of the application. Referring to FIG. 3, the control method for the heating device 100 executed by the controller 140 from any one of the embodiments of the application may include the following steps:
frequency matching step (S302): at each preset time interval t, controlling the electromagnetic wave generating system to adjust the frequency of the generated electromagnetic wave signal within a preset selectable frequency range, and ensuring the electromagnetic wave generating system meets a preset matching condition;
step of calculating a change amount (S304): recording the frequency of the electromagnetic wave signal that meets the preset matching condition each time, and calculating the change amount in frequency of the electromagnetic wave signal that meets the preset matching condition from before the preset number of matches to the current match;
heating termination step (S306): stopping the operation of the electromagnetic wave generating system when any of the preset termination conditions is met, where the preset termination conditions comprise the change amount being less than or equal to a preset change threshold S.

The control method of the application stops the operation of the electromagnetic wave generating system when the change amount in frequency that meets the frequency matching condition is less than or equal to the preset change threshold S, thus halting the heating of food at a state desired by the user, especially suitable for defrosting food. This prevents the object to be processed 150 from being overly defrosted, when defrosting is complete, the temperature is around −4 to −2° C., avoiding the production of blood water when the object to be processed 150 is meat, making it easier for users to cut.

In the frequency matching step (S302), the preset time interval t can be 25 s to 40 s, for example, 25 s, 30 s, or 40 s, to prevent misjudgment. The selectable frequency range can be 400 MHz to 500 MHz, to ensure the uniformity of the temperature of the object to be processed 150 and the efficiency of heating the object to be processed 150.

In the step of calculating a change amount (S304), the preset number of matches can be greater than or equal to 2, such as 3, to prevent misjudgment. The preset number of matches can also be 1, meaning the change amount is the difference in frequency of the electromagnetic wave signal that meets the preset matching condition between two consecutive times.

During the frequency matching step (S302), the power of the electromagnetic wave signal can be 5%˜10% of the power during other steps, to reduce the adverse effect on the object to be processed 150.

In some embodiments, during the frequency matching step (S302), the minimum value of the preset selectable frequency range to the frequency of the electromagnetic wave signal that met the preset matching condition in the previous instance is used as a selectable frequency range for the current frequency matching step, thereby determining a new selectable frequency range within the preset selectable frequency range, shortening the runtime of the frequency matching step (S302).

In the step of calculating a change amount (S304), calculating the difference between the frequency of the electromagnetic wave signal that meets the preset matching condition before the preset number of matches and the current match as the change amount, can shorten the time needed for calculating the change amount, enhancing the timeliness of ceasing heating the object to be processed 150.

In other embodiments, in the step of calculating a change amount (S304), the difference (absolute value) between the frequency of every two adjacent electromagnetic wave signals that meet the preset matching condition can be calculated first, and then all such differences are summed to obtain the change amount, to enhance accuracy.

In some embodiments, at the first execution of the frequency matching step (S302), the matching condition can be: the power of the reflected wave signal returned to the electromagnetic wave generation system being minimal, to facilitate subsequent frequency matching and shorten the time for subsequent frequency matching.

The control method of the application may also comprise a time determination step: determining a remaining heating time T for the object to be processed 150 based on the frequency of the electromagnetic wave signal that first meets the preset matching condition according to a preset comparison table. The comparison table records the relationship between different frequencies and the remaining heating time T.

The preset termination conditions may also comprise that continuation of the heating time for the object to be processed 150 to be longer than or equal to the determined remaining heating time T after the time determination step. That is, when the change amount in frequency that meets the frequency matching condition is less than or equal to the preset change threshold S, or continuation of the heating time for the object to be processed 150 to be longer than or equal to the determined remaining heating time T, the electromagnetic wave generating system is controlled to stop operating, to further ensure the object to be processed 150 has excellent quality upon completion of heating.

In other embodiments, when executing the frequency matching step (S302) for the first time and for a preset number of matches closely following the first time, the matching condition can be the same: the power of the reflected wave signal returned to the electromagnetic wave generating system being minimal.

The control method of the application may also comprise a time determination step: determining a remaining heating time T for the object to be processed 150 based on a sum of the differences (absolute value) in frequency between every two adjacent electromagnetic wave signals that meet the preset matching condition within the first time and the preset number of matches closely following the first time according to a preset comparison table. The comparison table records the relationship between the sum of the differences and the remaining heating time T.

The preset termination conditions may also comprise that continuation of the heating time for the object to be processed 150 after the time determination step to be longer than or equal to the determined remaining heating time T. That is, when the change amount in frequency that meets the frequency matching condition is less than or equal to the preset change threshold S, or continuation of the heating time for the object to be processed 150 to be longer than or equal to the determined remaining heating time T, the electromagnetic wave generating system is controlled to stop operating, to stop heating the object to be processed 150 more accurately and further ensure the object to be processed 150 has excellent quality upon heating completion.

In further embodiments, after the time determination step, the matching condition can be: the ratio of the power of the reflected wave signal returned to the electromagnetic wave generating system and the power of the incident wave signal propagated by the electromagnetic wave generating system to the cylinder being greater than or equal to a preset ratio threshold. The preset ratio threshold can be 70%˜80%.

When the ratio of the power of the reflected wave signal and the power of the incident wave signal is greater than or equal to the preset ratio threshold, the current frequency matching process ends, to reduce the adverse impact on the object to be processed 150 and increase the heating efficiency.

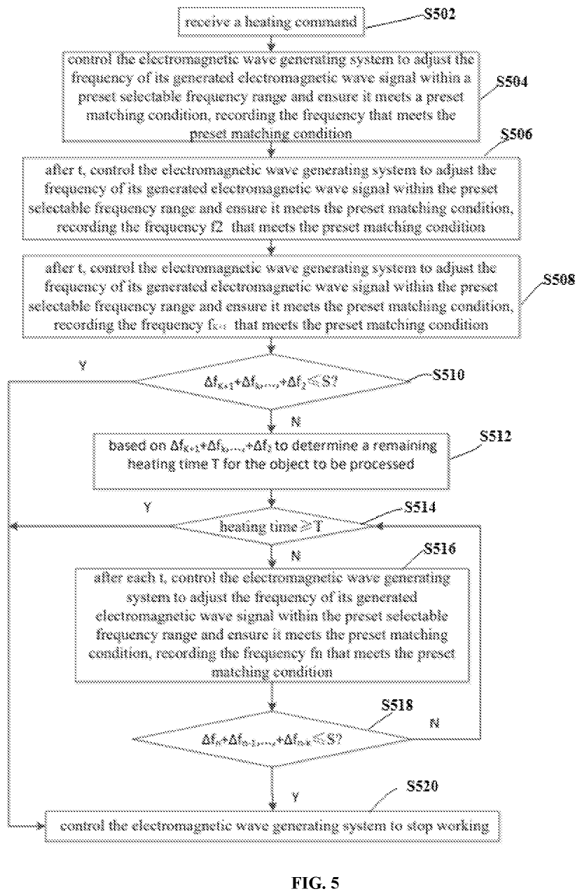

FIG. 4 is a schematic detailed flowchart of a control method for a heating device 100 according to an embodiment of the application (in FIGS. 4 and 5, “Y” indicates “Yes”; “N” indicates “No”). Referring to FIG. 4, the control method for the heating device 100 in one embodiment of the application may comprise the following detailed steps:
Step S402: receive a heating command.
Step S404: control the electromagnetic wave generating system to adjust the frequency of its generated electromagnetic wave signal within a preset selectable frequency range and ensure the electromagnetic wave generation system meets a preset matching condition, recording the frequency f1 of the electromagnetic wave signal that meets the preset matching condition.
Step S406: based on the frequency f1, according to a preset comparison table to determine a remaining heating time T for the object to be processed 150. The preset comparison table records the relationship between different frequencies and the remaining heating time T.
Step S408: determine if the continuation of the heating time for the object to be processed 150 after Step S406 is longer than or equal to the determined remaining heating time T. If yes, proceed to Step S414; if not, proceed to Step S410.
Step S410: After each preset time interval t, control the electromagnetic wave generating system to adjust the frequency of its generated electromagnetic wave signal within the preset selectable frequency range and ensure the electromagnetic wave generating system meets the preset matching condition, recording the frequency fn of the electromagnetic wave signal that meets the preset matching condition.
Step S412: determine if the sum of Δfₙ, Δfₙ₋₁, . . . , and Δfₙ₋ₖ is less than or equal to the preset change threshold S. If yes, proceed to Step S414; if not, return to Step S408. Wherein, Δfₙ=fₙ₋₁−fₙ; n represents the current frequency match; k is the preset number of matches.
Step S414: control the electromagnetic wave generating system to stop working.

FIG. 5 is a schematic detailed flowchart of a control method for a heating device 100 according to another embodiment of the application. Referring to FIG. 5, the control method for the heating device 100 in another embodiment of the application may comprise the following detailed steps:
Step S502: receive a heating command.
Step S504: control the electromagnetic wave generating system to adjust the frequency of its generated electromagnetic wave signal within a preset selectable frequency range and ensure the electromagnetic wave generation system meets a preset matching condition, recording the frequency f1 of the electromagnetic wave signal that meets the preset matching condition.
Step S506: after preset time interval t, control the electromagnetic wave generating system to adjust the frequency of its generated electromagnetic wave signal within the preset selectable frequency range and ensure the electromagnetic wave generating system meets the preset matching condition, recording the frequency f2 of the electromagnetic wave signal that meets the preset matching condition.
Step S508: after each preset time interval t, control the electromagnetic wave generating system to adjust the frequency of its generated electromagnetic wave signal within the preset selectable frequency range and ensure the electromagnetic wave generation system meets the preset matching condition until the k+1th frequency match, recording the frequency fₖ₊₁ of the electromagnetic wave signal that meets the preset matching condition. Here, k is the preset number of matches.
Step S510: determine if the sum of Δfₖ₊₁, Δfₖ, . . . , and Δf₂ is less than or equal to the preset change threshold S. If yes, proceed to Step S520; if not, proceed to Step S512. Here, Δfₖ₊₁=fₖ−fₖ₊₁.
Step S512: based on the sum of Δfₖ₊₁, Δfₖ, . . . , and Δf₂, according to a preset comparison table to determine the remaining heating time T for the object to be processed 150. Wherein, the preset comparison table records the relationship between different sum of differences and the remaining heating time T.
Step S514: determine if the continuation of the heating time for the object to be processed 150 after Step S512 is longer than or equal to the determined remaining heating time T. If yes, proceed to Step S520; if not, proceed to Step S516.
Step S516: after each preset time interval t, control the electromagnetic wave generating system to adjust the frequency of its generated electromagnetic wave signal within the preset selectable frequency range and ensure the electromagnetic wave generation system meets the preset matching condition, recording the frequency fₙ of the electromagnetic wave signal that meets the preset matching condition. Here, n represents the current frequency match.
Step S518: determine if the sum of Δfₙ, Δfₙ₋₁, . . . , and Δfₙ₋ₖ is less than or equal to the preset change threshold S. If yes, proceed to Step S520; if not, return to Step S514. Here, Δfₙ=fₙ₋₁−fₙ.
Step S520: control the electromagnetic wave generating system to stop working.

With this, those skilled in the art should recognize that, although this document has extensively shown and described multiple exemplary embodiments of the application many other variations or modifications that are in accordance with the principles of the application can be directly determined or derived without departing from the spirit and scope of the invention. Therefore, the scope of the application should be understood and interpreted to cover all such other variations or modifications.

1-10. (canceled)

11. A control method for a heating device, the heating device comprises a cylinder for placing an object to be processed, and an electromagnetic wave generating system for generating electromagnetic wave signals to heat the object to be processed, wherein the control method comprising:
frequency matching step: at each preset time interval, controlling the electromagnetic wave generating system to adjust the frequency of the generated electromagnetic wave signal within a preset selectable frequency range, and ensuring the electromagnetic wave generating system meets a preset matching condition;
step of calculating a change amount: recording the frequency of the electromagnetic wave signal that meets the preset matching condition each time, and calculating the change amount in frequency of the electromagnetic wave signal that meets the preset matching condition from before the preset number of matches to the current match;
heating termination step: stopping the operation of the electromagnetic wave generating system when any one of preset termination conditions is met, wherein,
the preset termination conditions comprise the change amount being less than or equal to a preset change threshold.

12. The control method according to claim 11, wherein:
in the frequency matching step, the minimum value of the preset selectable frequency range to the frequency of the electromagnetic wave signal that met the preset matching condition in the previous instance is used as a selectable frequency range for the current frequency matching step; and
in the step of calculating a change amount, the difference between the frequency of the electromagnetic wave signal that meets the preset matching condition before the preset number of matches and the current match is calculated as the change amount.

13. The control method according to claim 11, wherein:
in the step of calculating a change amount, the difference between the frequency of every two adjacent electromagnetic wave signals that meet the preset matching condition is calculated, and all such differences are summed to obtain the change amount.

14. The control method according to claim 11, wherein:
in the first frequency matching step, the preset matching condition comprises the power of the reflected wave signal returned to the electromagnetic wave generating system being minimal.

15. The control method according to claim 14, wherein, after the first frequency matching step is executed, it further comprises:
time determination step: determining a remaining heating time for the object to be processed based on the frequency of the electromagnetic wave signal that first meets the preset matching condition according to a preset comparison table, wherein, the comparison table records the relationship between frequency and the remaining heating time; and
the preset termination condition also comprises the heating time for the object to be processed being longer than or equal to the remaining heating time after the time determination step.

16. The control method according to claim 11, wherein,
when executing the frequency matching step for the first time and the preset number of matches closely following the first time, the preset matching condition comprises the power of the reflected wave signal returned to the electromagnetic wave generating system being minimal; and after executing the frequency matching step for the preset number of matches, the control method further comprises:
time determination step: determining a remaining heating time for the object to be processed based on a sum of the differences in frequency between every two adjacent electromagnetic wave signals that meet the preset matching condition within the first time and the preset number of matches closely following the first time according to a preset comparison table; wherein,
the comparison table records the relationship between the sum of the differences and the remaining heating time; and
the preset termination condition also comprises the heating time for the object to be processed being longer than or equal to the remaining heating time after the time determination step.

17. The control method according to claim 15, wherein,
after the time determination step, the preset matching condition comprises the ratio of the power of the reflected wave signal returned to the electromagnetic wave generating system and the power of the incident wave signal propagated by the electromagnetic wave generating system to the cylinder being greater than or equal to a preset ratio threshold;
when the condition of the preset matching condition being met occurs, the current frequency matching step is terminated.

18. The control method according to claim 16, wherein,
after the time determination step, the preset matching condition comprises the ratio of the power of the reflected wave signal returned to the electromagnetic wave generating system and the power of the incident wave signal propagated by the electromagnetic wave generating system to the cylinder being greater than or equal to a preset ratio threshold;
when the condition of the preset matching condition being met occurs, the current frequency matching step is terminated.

19. The control method according to claim 11, wherein,
the preset number of matches is greater than or equal to 2.

20. The control method according to claim 11, wherein,
the preset time interval is 25 s˜40 s.

21. A heating device, characterized in that, it comprises:
a cylinder for placing an object to be processed;
an electromagnetic wave generating system, configured to generate electromagnetic wave signals for heating the object to be processed; and
a controller, configured to execute the control method according to claim 11.
